(19) United States
(12) Patent Application Publication
(10) Pub. No.: US 2019/0173709 A1
(43) Pub. Date: Jun. 6, 2019

(54) APPARATUS AND METHOD FOR REDUCING SIGNAL DISTORTION

(71) Applicant: Electronics and Telecommucications Research Institute, Daejeon (KR)

(72) Inventors: Myung-Sun BAEK, Daejeon (KR); Jin-Hyuk SONG, Daejeon (KR); Joon-Young JUNG, Daejeon (KR); Heung-Mook KIM, Daejeon (KR)

(73) Assignee: Electronics and Telecommunications Research Institute, Daejeon (KR)

(21) Appl. No.: 16/018,101

(22) Filed: Jun. 26, 2018

(30) Foreign Application Priority Data
Dec. 5, 2017 (KR) 10-2017-0166149

(51) Int. Cl. H04L 27/26; H04J 11/00; H04L 5/14

(52) U.S. Cl. CPC H04L 27/2618; H04L 5/14; H04J 11/0023; H04L 27/2628

(57) ABSTRACT

Disclosed herein are an apparatus and method for reducing signal distortion. The apparatus for reducing signal distortion includes a signal input unit for receiving Orthogonal Frequency Division Multiplexing (OFDM) signals, a symbol selection unit for selecting an OFDM symbol having a lowest Peak-to-Average-Power-Ratio (PAPR) by applying selective mapping (SLM) to the OFDM signals, an information generation unit for generating side information that includes information about a phase-shift sequence of the selected OFDM symbol, and a signal output unit for outputting a resulting signal by adding the side information to the selected OFDM symbol.

### CROSS REFERENCE TO RELATED APPLICATION

This application claims the benefit of Korean Patent Application No. 10-2017-0166149, filed Dec. 5, 2017, which is hereby incorporated by reference in its entirety into this application.

### BACKGROUND OF THE INVENTION

### 1. Technical Field

The present invention relates generally to full-duplex communication technology, and more particularly, to technology for reducing signal distortion occurring in full-duplex communication.

### 2. Description of the Related Art

When a base station and a terminal communicate with each other using uplink/downlink channels, a typical communication system prevents interference from occurring between uplink and downlink signals by dividing a frequency or time band.

Here, uplink/downlink communication for dividing a frequency band is referred to as “Frequency Division Duplex (FDD)”, and uplink/downlink communication for dividing a time band is referred to as “Time Division Duplex (TDD)”.

Since FDD or TDD transmits uplink/downlink signals, frequency use efficiency may be decreased. However, full-duplex communication, which is a scheme for simultaneously transmitting uplink/downlink signals, can overcome the disadvantage of decreased frequency use efficiency. Since full-duplex communication is a not a scheme for dividing a frequency or time band and transmitting signals, frequency efficiency may be effectively improved.

However, such full-duplex communication may have limitations in that, during a procedure for receiving a signal from a transmitting end while transmitting a self-signal, the self-signal is applied as interference. Therefore, the full-duplex communication needs a procedure for effectively modeling and eliminating a self-signal that is fed back from the transmitting end in order for a receiving end to effectively detect a signal transmitted from the transmitting end.

Further, since the self-signal is amplified by a High-Power Amplifier (HPA) and applied from the transmitting antenna of the same system, the self-signal has very high power compared to a desired reception signal. Moreover, when a self-interference signal is an Orthogonal Frequency Division Multiplexing (OFDM) signal, a time-domain OFDM signal is composed of independently modulated subcarriers. Therefore, when these subcarriers are added in phase, a higher-intensity signal is produced, and thus a high Peak-to-Average-Power-Ratio (PAPR) appears.

Therefore, full-duplex communication requires a procedure for eliminating a PAPR to effectively model a self-interference signal.

Meanwhile, Korean Patent Application Publication No. 10-2015-0119263 discloses technology entitled “Method and Apparatus for Managing Interference in Full-Duplex Communication”. This technology discloses an apparatus and method that receive an intended signal from a first wireless device operating in a full-duplex mode and receive an interfering signal from a second wireless device for communicating with the first wireless device, and that project a matrix of the received intended signal onto a space associated with the interfering signal, thus reducing interference of the signal caused by the interfering signal.

### SUMMARY OF THE INVENTION

Accordingly, the present invention has been made keeping in mind the above problems occurring in the prior art, and an object of the present invention is to reduce signal distortion in an Orthogonal Frequency Division Multiplexing (OFDM) transmission signal in a full-duplex communication system.

Another object of the present invention is to reduce signal distortion by decreasing a Peak-to-Average-Power-Ratio (PAPR) occurring in a procedure for performing an IFFT on an OFDM signal.

A further object of the present invention is to reduce the size of side information required for selective mapping (SLM) so as to effectively decrease a PAPR.

In accordance with an aspect of the present invention to accomplish the above objects, there is provided an apparatus for reducing signal distortion, including a signal input unit for receiving Orthogonal Frequency Division Multiplexing (OFDM) signals; a symbol selection unit for selecting an OFDM symbol having a lowest Peak-to-Average-Power-Ratio (PAPR) by applying selective mapping (SLM) to the OFDM signals; an information generation unit for generating side information that includes information about a phase-shift sequence of the selected OFDM symbol; and a signal output unit for outputting a resulting signal by adding the side information to the selected OFDM symbol.

The signal output unit may add the side information to a message block of a Physical Link Channel (PLC) frame in the selected OFDM symbol.

The signal output unit may primarily transmit an OFDM symbol including the side information and secondarily output an OFDM symbol corresponding to the side information.

The signal input unit may output the OFDM signals such that the OFDM signals are divided into at least two OFDM signal groups.

The symbol selection unit may generate OFDM symbol groups by applying selective mapping to each of the at least two OFDM signal groups.

The symbol selection unit may calculate average PAPR values of OFDM symbols included in the at least two OFDM symbol groups and select OFDM symbols having a lowest average PAPR.

The symbol selection unit may calculate an average PAPR of OFDM symbols which are included in the at least two OFDM symbol groups and which are generated using an identical phase-shift sequence.

In accordance with another aspect of the present invention to accomplish the above objects, there is provided a method for reducing signal distortion, the method being performed using a signal distortion reduction apparatus, the method including receiving Orthogonal Frequency Division Multiplexing (OFDM) signals; selecting an OFDM symbol having a lowest Peak-to-Average-Power-Ratio (PAPR) by applying selective mapping (SLM) to the OFDM signals; generating side information that includes information about a phase-shift sequence of the selected OFDM symbol; and outputting a resulting signal by adding the side information to the selected OFDM symbol.

Outputting the resulting signal may be configured to add the side information to a message block of a Physical Link Channel (PLC) frame in the selected OFDM symbol.

Outputting the resulting signal may be configured to primarily transmit an OFDM symbol including the side information and secondarily output an OFDM symbol corresponding to the side information.

Receiving the OFDM signals may be configured to output the OFDM signals such that the OFDM signals are divided into at least two OFDM signal groups.

Selecting the OFDM symbol may be configured to generate OFDM symbol groups by applying selective mapping to each of the at least two OFDM signal groups.

Selecting the OFDM signal may be configured to calculate average PAPR values of OFDM symbols included in the at least two 01-DM symbol groups and select OFDM symbols having a lowest average PAPR.

Selecting the OFDM signal may be configured to calculate an average PAPR of OFDM symbols which are included in the at least two OFDM symbol groups and which are generated using an identical phase-shift sequence.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating an uplink/downlink communication scheme in frequency-division duplex and time-division duplex;

FIG. 2 is a diagram illustrating overlapping between subcarriers of an OFDM signal;

FIG. 3 is a graph illustrating overlapping between subcarriers of an OFDM signal;

FIG. 4 is a block diagram illustrating a full-duplex communication device according to an embodiment of the present invention;

FIG. 5 is a block diagram illustrating an apparatus for reducing signal distortion according to an embodiment of the present invention;

FIG. 6 is a diagram illustrating selective mapping according to an embodiment of the present invention;

FIG. 7 is a diagram illustrating the structure of OFDM symbols selected using selective mapping according to an embodiment of the present invention;

FIG. 8 is a diagram illustrating the structure of an OFDM channel in a DOCSIS 3.1 system according to an embodiment of the present invention;

FIG. 9 is a diagram illustrating a PLC frame included in the OFDM channel of the DOCSIS 3.1 system according to an embodiment of the present invention;

FIG. 10 is a diagram illustrating the message block of the DOCSIS 3.1 system according to an embodiment of the present invention;

FIG. 11 is a diagram illustrating selective mapping for reducing the size of side information according to an embodiment of the present invention;

FIG. 12 is a diagram illustrating the structure of OFDM symbols selected using selective mapping for reducing the size of side information according to an embodiment of the present invention;

FIG. 13 is an operation flowchart illustrating a method for reducing signal distortion according to an embodiment of the present invention; and

FIG. 14 is an operation flowchart illustrating a signal distortion reduction method for reducing the size of side information according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

In the present specification, it should be understood that terms such as “include” or “have” are merely intended to indicate that features, numbers, steps, operations, components, parts, or combinations thereof are present, and are not intended to exclude the possibility that one or more other features, numbers, steps, operations, components, parts, or combinations thereof will be present or added.

Hereinafter, embodiments of the present invention will be described in detail with reference to the attached drawings.

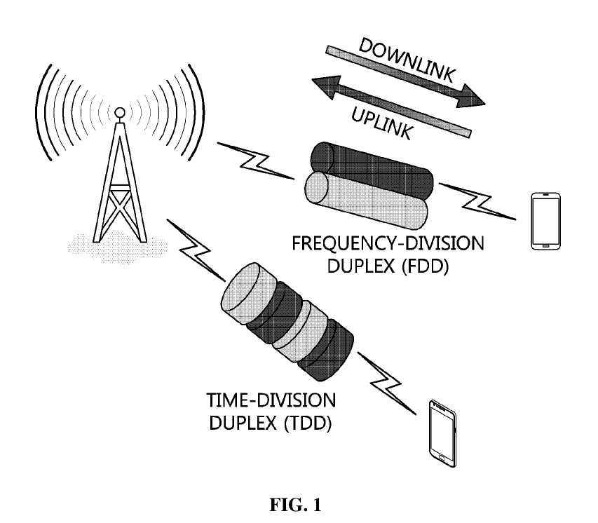

FIG. 1 is a diagram illustrating an uplink/downlink communication scheme in frequency-division and time-division communication.

Referring to FIG. 1, it can be seen that Frequency-Division Duplex (FDD) and Time-Division Duplex (TDD) uplink/downlink communication schemes are depicted.

However, since uplink/downlink signals are transmitted by dividing a frequency band or a time band, frequency use efficiency is deteriorated. Therefore, in order to overcome this disadvantage, a Full-Duplex (DD) communication scheme, which is a simultaneous uplink/downlink transmission scheme, is required.

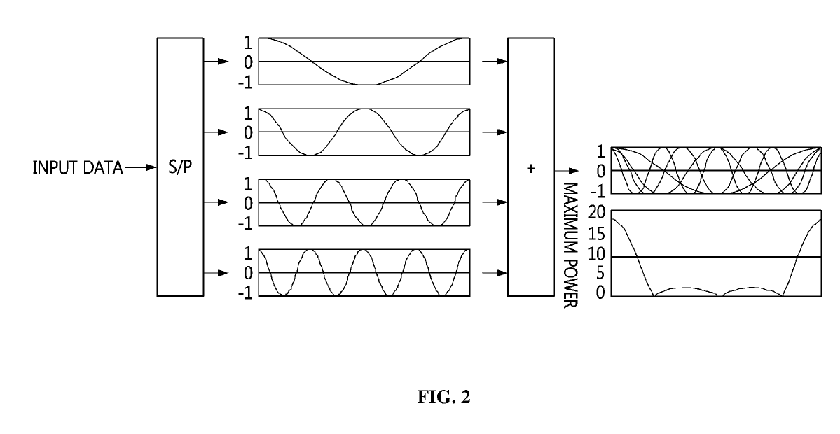

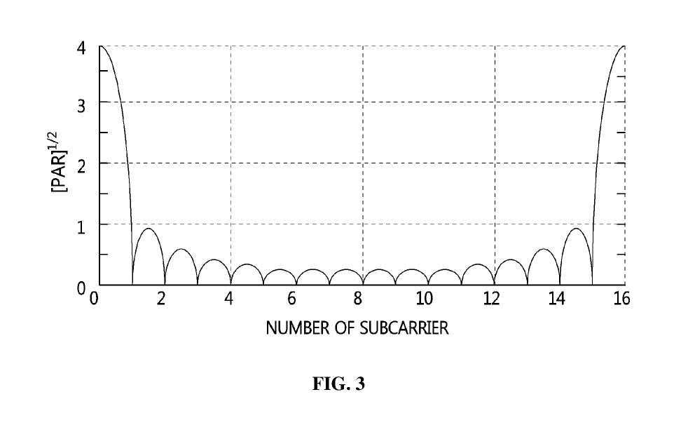

FIGS. 2 and 3 are a diagram and a graph respectively illustrating overlapping between subcarriers of an OFDM signal.

Referring to FIG. 2, it can be seen that overlapping between subcarriers of an OFDM signal is depicted.

Pieces of input data that are respectively received in series are converted into a number of parallel data symbols identical to the number of subcarriers. The length of the converted parallel data symbols in a time domain may be extended by a multiple of the number of subcarriers. In this case, it can be seen that, in data symbols, a high Peak-to-Average-Power-Ratio (PAPR) occurs due to an increase in peak power attributable to overlapping between subcarriers.

Referring to FIG. 3, the square root of the PAPR to the number of subcarriers of an OFDM signal is depicted.

As a plurality of signals are added in phase, peak power is increased by a multiple of the number of subcarriers compared to average power. In this case, the same subcarriers are modulated in the same initial phase.

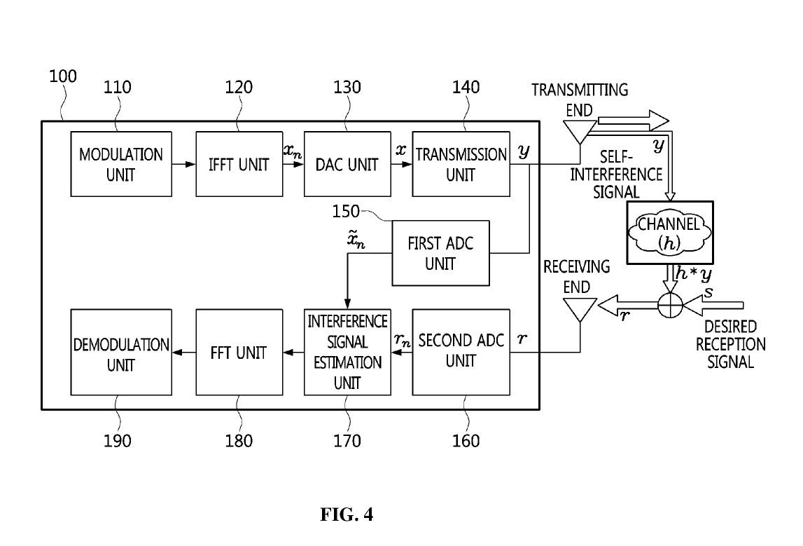

FIG. 4 is a block diagram illustrating a full-duplex communication device according to an embodiment of the present invention.

Referring to FIG. 4, an OFDM-based full-duplex communication device 100 according to an embodiment of the present invention includes a modulation unit 110, an Inverse Fast Fourier Transform (IFFT) unit 120, a Digital-to-Analog Conversion (DAC) unit 130, a transmission unit 140, a first Analog-to-Digital Conversion (ADC) unit 150, a second ADC unit 160, an interference signal estimation unit 170, a Fast Fourier Transform (FFT) unit 180, and a demodulation unit 190.

The modulation unit 110 may generate and modulate a signal.

The IFFT unit 120 may perform an IFFT on the modulated signal.

The DAC unit 130 may perform DAC on the IFFT-transformed signal.

The transmission signal 140 may transmit an uplink transmission signal, converted into an analog signal, to a base station or an additional terminal device through a transmitting end.

Here, the transmission signal 140 may amplify the transmission signal using a High-Power Amplifier (HPA).

The transmission signal amplified by the HPA may have power much higher than that of a reception signal.

Here, when the transmission frequency of the transmission signal that is to be transmitted and the reception frequency of the reception signal that is received are identical to each other, self-interference may occur at the receiving end of the full-duplex communication device 100 if the transmission signal is added to the reception signal.

The self-interference signal may be a high-power signal having passed through the HPA.

However, the reception signal may be a low-power signal received after being transmitted from a relatively long distance away.

Therefore, when the self-interference signal is an OFDM signal, the OFDM signal in a time domain may be composed of independently modulated subcarriers. When subcarriers are added in phase, a large-intensity signal is produced, and a high Peak-to-Average-Power-Ratio (PAPR) may occur.

Therefore, when a self-interference signal having high power has a high PAPR, quantization noise occurring in the ADC unit of the full-duplex communication device 100 may be greatly increased.

The first ADC unit 150 may perform ADC on the transmission signal.

The second ADC unit 160 may perform ADC on the reception signal.

The interference signal estimation unit 170 may estimate a self-interference signal from the transmission signal and the reception signal, converted into digital signals.

Here, the interference signal estimation unit 170 may cancel the estimated self-interference signal from the reception signal.

The FFT 180 may perform a Fast Fourier Transform (FFT) on the self-interference signal-cancelled reception signal.

The demodulation unit 190 may demodulate the FFT-transformed reception signal.

Here, an apparatus for reducing signal distortion according to an embodiment of the present invention may be coupled to the full-duplex communication device to reduce a PAPR occurring in an IFFT procedure, or may be included in the IFFT unit 120 to directly reduce a PAPR.

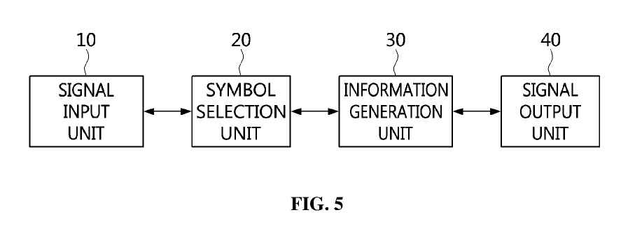

FIG. 5 is a diagram illustrating an apparatus for reducing signal distortion according to an embodiment of the present invention.

Referring to FIG. 5, the signal distortion reduction apparatus according to the embodiment of the present invention includes a signal input unit 10, a symbol selection unit 20, an information generation unit 30, and a signal output unit 40.

The signal input unit 10 may receive an Orthogonal Frequency Division Multiplexing (OFDM) signal.

The symbol selection unit 20 may select an OFDM symbol having the lowest Peak-to-Average-Power-Ratio (PAPR) by applying selective mapping (SLM) to the OFDM signal.

Here, when a self-interference signal is X, the symbol selection unit 20 may represent the output of an II-FT-transformed self-interference signal by the following Equation (1):

xᵢ(n)=IFFT[Xᵢ(k)] (1)

where xᵢ (n) may denote an n-th sample of an i-th OFDM symbol. The i-th OFDM symbol composed of N samples may be represented by the following Equation (2):

xᵢ=[xᵢ(0)xᵢ(1) . . . xᵢ(n) . . . xᵢ(N−1)] (2)

In this case, the symbol selection unit 20 may calculate a PAPR of the OFDM signal using the following Equation (3):

$$PAPR = \frac{max {\vert {x}_{i} ( n ) \vert}^{2}}{E [ {\vert {x}_{i} ( n ) \vert}^{2} ]} \qquad ( 3 )$$

In Equation (3), max|xᵢ(n)|² may denote the maximum peak envelope power of the i-th OFDM symbol. E[|xᵢ(n)|²] may denote average power. When the number of subcarriers is N, the maximum PAPR that the OFDM symbol can have may be N. Meanwhile, a Complementary Cumulative Distribution Function (CCDF) may be used as the index of signal distortion reduction performance, and may be represented by the following Equation (4):

Fₓ(x)=Pr[x>x₀] (4)

In Equation (4), when x is set to the PAPR of the signal and x₀ is set to the threshold of the PAPR, the CCDF of the PAPR may be the probability that the PAPR will be greater than the threshold.

The symbol selection unit 20 may reduce the PAPR of the signal using selective mapping (SLM).

Here, before the IFFT operation of converting the OFDM signal from a frequency-domain signal into a time-domain signal is performed, the symbol selection unit 20 may multiply a plurality of phase-shift sequences by the frequency-domain signal, and may then perform an IFFT on multiplied signals, thus calculating a PAPR.

Here, the symbol selection unit 20 may multiply V phase-shift sequences having phase shift vectors by the input OFDM signal, as given by the following Equation (5):

P=[P⁽¹⁾P⁽²⁾ . . . P^{(v)} . . . P^{(V)}] (5)

The v-th sequence P^{(v)} in Equation (5) may be represented by the following Equation (6):

P^{(v)=[}p₀^{(v)}p₁^{(v)} . . . pₙ^{(v)} . . . p_{N-1}^{(v)}], Pₙ^{(v)∈{±1,±j}} (6)

Here, the symbol selection unit 20 may output signals to which the phase-shift sequences have been applied, as represented by the following Equation (7):

Xᵢ^{(v)}=Xᵢ·P^{(v)}, 1≤v≤V (7)

Here, the symbol selection unit 20 may perform an IFFT on the signals to which the phase-shift sequences have been applied.

The symbol selection unit 20 may calculate PAPR values for the signals on which IFFT has been performed.

Here, the symbol selection unit 20 may select an OFDM symbol having the lowest PAPR, as represented by the following Equation (8).

$${\tilde{v}}_{i} = arg {min}_{1 \leq v \leq V} [ {max}_{1 \leq n \leq N} \vert {x}_{i}^{( v )} ( n ) \vert ] \qquad ( 8 )$$

In Equation (8), \tilde{v}ᵢ denotes the index of an OFDM symbol having the lowest PAPR, among V independent OFDM symbols for the i-th OFDM symbol. Therefore, the OFDM symbol may be represented by xᵢ^{(\tilde{v}}^{ᵢ}⁾.

The information generation unit 30 may generate side information including information about the phase-shift sequence of the selected OFDM symbol.

The receiving end requires side information about the phase-shift sequences P^{(\tilde{v}}^{ᵢ}⁾ for all selected OFMD symbols so as to restore the reception signal.

Here, the information generation unit 30 may generate side information in which the number of bits to be transmitted for each selected OFDM symbol is log₂ V.

The signal output unit 40 may output a signal by adding the side information to each selected OFDM symbol.

The signal output unit 40 may add the side information to the message block of a Physical Link Channel (PLC) frame in each selected OFDM symbol.

Here, the signal output unit 40 may primarily transmit OFDM symbols including the side information and secondarily output OFDM symbols corresponding to the side information.

The signal output unit 40 may include the side information in the corresponding OFDM symbols without applying a PAPR cancellation technique to the OFDM symbols including the side information.

Further, the signal input unit 10 may divide the input OFDM signal into at least two OFDM signal groups and then output the OFDM signal groups.

In this case, when the number of OFDM symbols to be transmitted is equal to or greater than a preset number, or when the input OFDM signal is composed of OFDM symbols in which the length of one frame is very large, the signal input unit 10 may output the input OFDM signal by dividing the OFDM signal into at least two OFDM signal groups.

Here, the symbol selection unit 20 may generate OFDM symbol groups by applying selective mapping (SLM) to each of the at least two OFDM signal groups.

The symbol selection unit 20 may calculate the average PAPR of the OFDM symbols which are included in at least two OFDM symbol groups and which are generated using the same phase-shift sequence.

Here, the symbol selection unit 20 may calculate the average PAPR values of the OFDM symbols included in the at least two OFDM symbol groups, and may select OFDM symbols having the lowest average PAPR.

Therefore, assuming that one frame is composed of K OFDM symbols, a total of K·log₂ V bits may be required. In this case, when an available band that enables side information to be transmitted is present in a PAPR header, the optimal PAPR may be achieved when all of the side information is transmitted. Conversely, when there is no available band, it may be more effective to use a method for reducing the number of bits required for side information.

The symbol selection unit 20 may select OFDM symbols having the lowest average PAPR, as given by the following Equation (9):

$$\tilde{v} = arg {min}_{1 \leq v \leq V} [ \frac{1}{G} {\sum }_{i = 1}^{G} {max}_{1 \leq n \leq N} \vert {x}_{i}^{( v )} ( n ) \vert ] \qquad ( 9 )$$

The information generation unit 30 may generate side information including information about the phase-shift sequences of the selected OFDM symbols.

The receiving end requires side information about the phase-shift sequences P^{(\tilde{v}}^{ᵢ}⁾ of all selected OFDM symbols in order to restore the reception signal.

Here, the information generation unit 30 may generate side information in which the number of bits to be transmitted for each selected OFDM symbol is log₂ V.

The signal output unit 40 may add the side information to the selected OFDM symbols, and may then output a resulting signal.

Here, the signal output unit 40 may add the side information to the message block of the Physical Link Channel (PLC) frame of each selected OFDM symbol.

The signal output unit 40 may primarily transmit OFDM symbols including the side information and secondarily output OFDM symbols corresponding to the side information.

Here, the signal output unit 40 may include the side information in the corresponding OFDM symbols without applying a PAPR cancellation technique to the OFDM symbols including the side information.

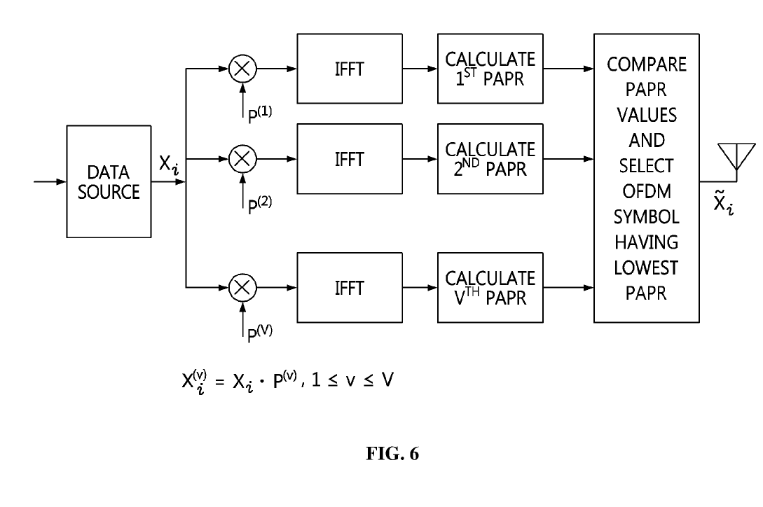

FIG. 6 is a diagram illustrating selective mapping according to an embodiment of the present invention.

Referring to FIG. 6, it can be seen that an OFDM symbol having the lowest PAPR is selected using selective mapping according to an embodiment of the present invention.

First, in selective mapping, phase conversion may be performed in such a way as to receive an OFDM signal xᵢ, multiply the OFDM signal by phase-shift sequences P^{(v)}, and then convert a frequency-domain signal into a time-domain signal.

Here, OFDM symbols may be generated by performing an IFFT on phase-converted signals for respective phase-shift sequences.

The PAPR values may be calculated for respective OFDM symbols.

Here, the selection of an OFDM symbol may be performed in such a way as to compare PAPR values of OFDM symbols and select an OFDM symbol having the lowest PAPR, and the selected OFDM symbol xᵢ^{(\tilde{v}}^{ᵢ}⁾ may be transmitted through the transmitting end.

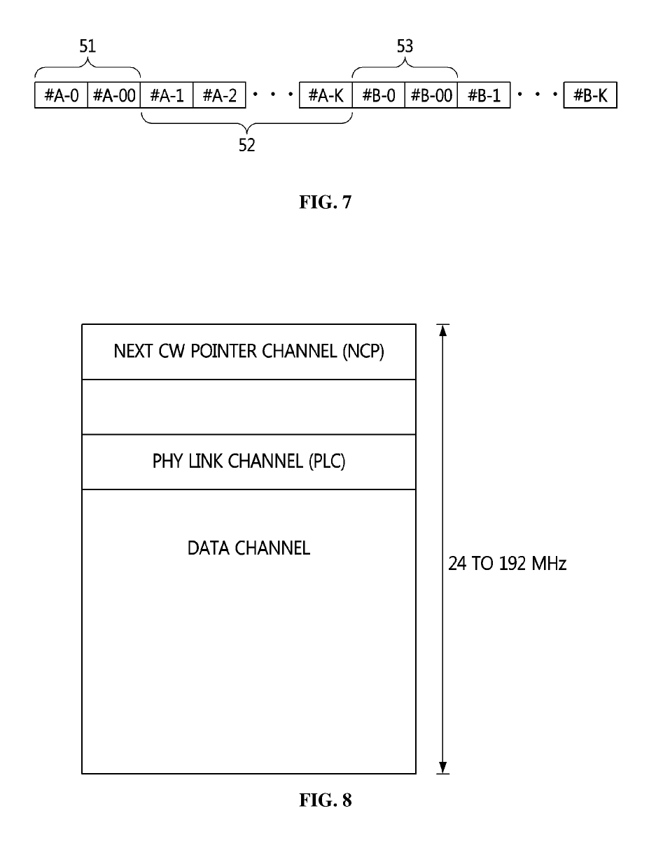

FIG. 7 is a diagram illustrating the structure of OFDM symbols selected using selective mapping according to an embodiment of the present invention.

Referring to FIG. 7, it can be seen that the structure of OFDM symbols selected using selective mapping according to an embodiment of the present invention is depicted.

The OFDM symbols may include PAPR headers 51 and 53 and a PAPR frame 52.

The PAPR headers 51 and 53 may correspond to one or two OFDM symbols.

In this case, the PAPR headers 51 and 53 may include side information, and a PAPR reduction technique may not be applied to the PAPR headers 51 and 53.

The PAPR frame 52 may be composed of K OFDM symbols, and a PAPR reduction technique may be applied to the PAPR frame 52.

Here, when a total of K OFDM symbols are transmitted, K·logₑ V bits may be required for the side information.

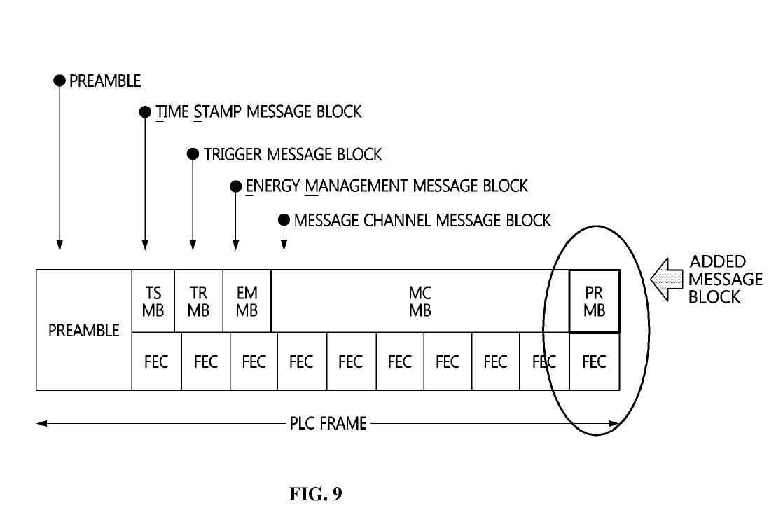

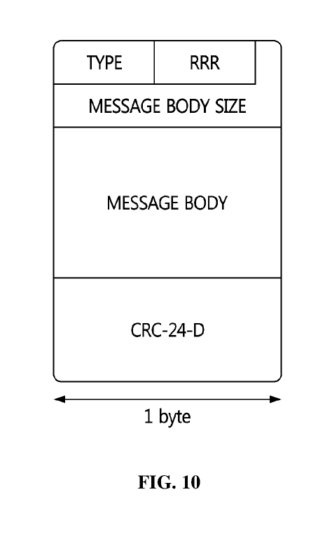

FIG. 8 is a diagram illustrating the structure of an OFDM channel in a Data Over Cable Service Interface Specification (DOCSIS) 3.1 system according to an embodiment of the present invention. FIG. 9 is a diagram illustrating a PLC frame included in the OFDM channel of the DOCSIS 3.1 system according to an embodiment of the present invention. FIG. 10 is a diagram illustrating the message block of the DOCSIS 3.1 system according to an embodiment of the present invention.

Referring to FIG. 8, the structure of the OFDM channel in the DOCSIS 3.1 system according to an embodiment of the present invention is depicted.

As illustrated in FIG. 8, the structure of the OFDM channel in the DOCSIS 3.1 system according to the embodiment of the present invention may include a Physical Link Channel (PCL).

Referring to FIG. 9, a PLC frame included in the OFDM channel of the DOCSIS 3.1 system according to the embodiment of the present invention is depicted.

Here, side information may be included in the message block of the PLC frame.

In detail, a PAPR-related message block (MB) may be added to a specific portion of the PLC frame.

Referring to FIG. 10, the message block of the DOCSIS 3.1 system according to the embodiment of the present invention may be a generic format of a message block for future use.

Therefore, PAPR-related signaling may be added to the corresponding MB.

Information included in the message block to which side information is to be added according to an embodiment of the present invention may be described as shown in Table 1.

TABLE 1

| Field | Size | | Value | Description |
|---|---|---|---|---|
| Message Block Type | 4 | bits | 5 | |
| R | 3 | bits | 0 | Reserved |
| Message Body Size | 9 | bits | 64 | The length of the |
| | | | | Message Body field |
| | | | | specified in octets. |
| PAPR Cancellation- | 512 | bits | TBD | TBD |
| related | | | | |
| Message Body | | | | |
| CRC | 3 | bytes | | CRC-24-D |

Further, the PAPR cancellation-related message body field described in Table 1 may be stated in detail, as shown in Table 2.

TABLE 2

| Field | Size | | Value | Description |
|---|---|---|---|---|
| PAPR ON | 1 | bits | | PAPR on/off selection |
| PAPR Mode | 7 | bits | 0-SLM | PAPR Mode |
| | | | 1-PTS | |
| | | | 2-TBD | |
| | | | (others) | |
| PAPR reduction value | 63 | bytes | 0-503 | PAPR Reduction Value |

In this case, an example of the message body stated in Table 2 may be changed by a user.

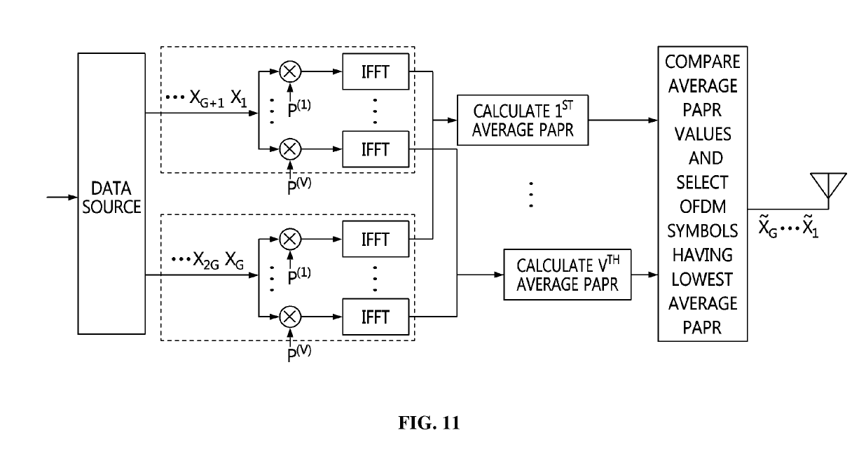

FIG. 11 is a diagram illustrating selective mapping for reducing the size of side information according to an embodiment of the present invention.

Referring to FIG. 11, selective mapping for reducing the size of side information is depicted.

For this, selective mapping is configured to output an input OFDM signal by dividing the input OFDM signal into at least two OFDM signal groups.

Here, at least two OFDM symbol groups may be generated by applying phase-shift sequences to each of the at least two OFDM signal groups and by performing an IFFT on the applied results.

Here, OFDM symbols having the lowest average PAPR may be selected by calculating the average PAPR values of OFDM symbols included in the at least two OFDM symbol groups.

Here, it can be seen that the OFDM symbols having the lowest average PAPR are selected by calculating the average PAPR values of OFDM symbols which are included in the at least two OFDM symbol groups and which are generated using the same phase-shift sequence.

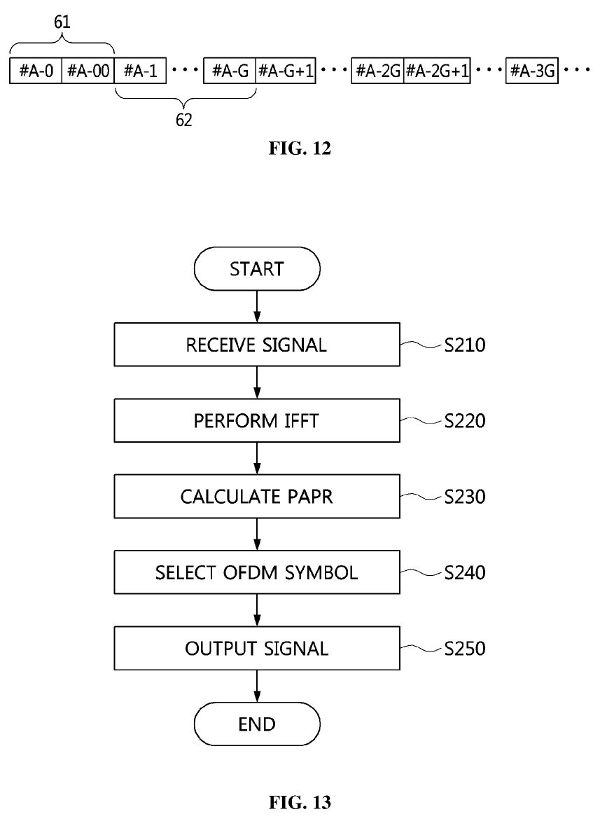

FIG. 12 is a diagram illustrating the structure of OFDM symbols selected using selective mapping for reducing the size of side information according to an embodiment of the present invention.

Referring to FIG. 12, it can be seen that the structure of OFDM symbols selected using selective mapping for reducing the size of side information according to the embodiment of the present invention is depicted.

The OFDM symbols may include a PAPR header 61 and a PAPR frame 62.

The PAPR header 61 may correspond to one or two OFDM symbols.

The PAPR header 61 may include side information, and a PAPR reduction technique may not be applied to the PAPR header 61.

The PAPR frame 62 may be composed of G OFDM symbols, and the PAPR reduction technique may be applied to the PAPR frame 62.

In this case, when a total of K OFDM symbols are transmitted, K·log₂ V bits may be required for the side information.

In this case, the number of bits of side information required for G OFDM symbols is log₂ V. When G>1, this value is less than that of the case where the number of bits of side information required in a typical PAPR cancellation technique is G·log₂ V. When the total length of the entire frame is K, and L=K/G is assumed, the number of bits of side information required in the PAPR cancellation technique for one frame is L·log₂ V. In contrast, the number of bits of side information required in the typical PAPR cancellation technique is K·log₂ V.

FIG. 13 is an operation flowchart illustrating a method for reducing signal distortion according to the embodiment of the present invention.

Referring to FIG. 13, the signal distortion reduction method according to the embodiment of the present invention may receive a signal at step S210.

That is, at step S210, an Orthogonal Frequency Division Multiplexing (OFDM) signal may be received.

Next, the signal distortion reduction method according to the embodiment of the present invention may perform an IFFT at step S220.

That is, at step S220, V phase-shift sequences having phase shift vectors may be multiplied by the input OFDM signal, as shown in Equation (5).

At step S220, signals to which the phase-shift sequences have been applied may be output, as shown in Equation (7).

At step S220, the IFFT may be performed on the signals to which the phase-shift sequences have been applied.

Next, the signal distortion reduction method according to the embodiment of the present invention may calculate a PAPR at step S230.

That is, at step S230, the PAPR of each signal on which the IFFT has been performed may be calculated using Equation (3).

Then, the signal distortion reduction method according to the embodiment of the present invention may select an OFDM symbol at step S240.

That is, at step S240, the OFDM symbol having the lowest PAPR may be selected, as shown in Equation (8).

Thereafter, the signal distortion reduction method according to the embodiment of the present invention may output a signal at step S250.

That is, at step S250, side information including information about the phase-shift sequence of the selected OFDM symbol may be generated.

A receiving end requires side information about the phase-shift sequences P^{(\tilde{v}}^{ᵢ}⁾ for all selected OFDM symbols so as to restore a reception signal

At step S250, a resulting signal may be output by adding the side information to the selected OFDM symbol.

At step S250, the side information may be added to the message block of a Physical Link Channel (PLC) frame in the selected OFDM symbol.

Further, at step S250, OFDM symbols including the side information may be primarily transmitted, and OFDM symbols corresponding to the side information may be secondarily output.

Here, at step S250, the side information may be included in the corresponding symbols without applying a PAPR cancellation technique to the OFDM symbols including the side information.

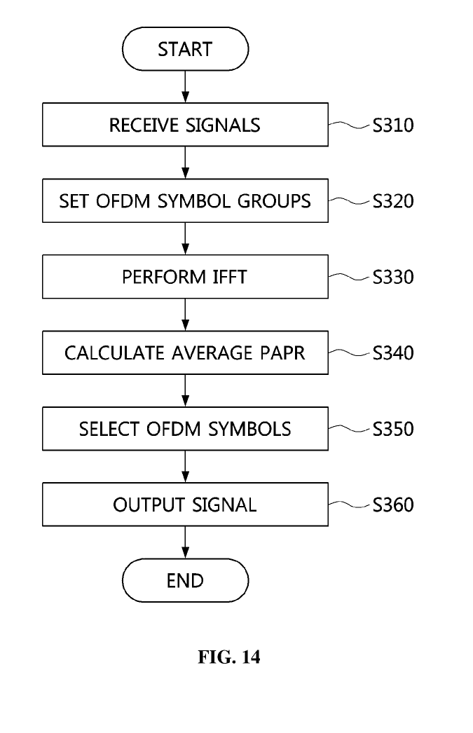

FIG. 14 is an operation flowchart illustrating a method for reducing signal distortion in an OFDM signal group according to an embodiment of the present invention.

Referring to FIG. 14, the signal distortion reduction method according to the embodiment of the present invention may receive signals at step S310.

That is, at step S310, OFDM signals may be received.

Further, the signal distortion reduction method according to the embodiment of the present invention may set OFDM symbol groups at step S320.

In detail, at step S320, the received OFDM signals may be output such that they are divided into at least two OFDM signal groups.

For example, at step S320, when the number of OFDM symbols to be transmitted is equal to or greater than a preset number or when the input OFDM signal is composed of OFDM symbols in which the length of one frame is very large, the received OFDM signals may be output such that they are divided into at least two OFDM signal groups.

Next, the signal distortion reduction method according to the embodiment of the present invention may perform an IFFT at step S330.

That is, at step S330, V phase-shift sequences having phase shift vectors may be multiplied by each signal included in the set OFDM signal groups, as shown in Equation (5).

Here, at step S330, signals to which the phase-shift sequences have been applied may be output, as shown in Equation (7).

At step S330, an IFFT may be performed on the signals to which the phase-shift sequences have been applied.

In this case, at step S330, OFDM symbol groups may be generated by performing an IFFT on each of the at least two OFDM signal groups.

Next, the signal distortion reduction method according to the embodiment of the present invention may calculate an average PAPR at step S340.

That is, at step S340, the PAPR values of the signals on which the IFFT has been performed may be calculated using Equation (3).

Here, at step S340, the average PAPR of the OFDM symbols which are included in at least two OFDM symbol groups and which are generated using the same phase-shift sequence may be calculated.

Then, the signal distortion reduction method according to the embodiment of the present invention may select OFDM symbols at step S350.

That is, at step S350, OFDM symbols having the lowest average PAPR may be selected by calculating the average PAPR values of the OFDM symbols included in the at least two OFDM symbol groups.

Thereafter, the signal distortion reduction method according to the embodiment of the present invention may output a signal at step S360.

That is, at step S360, side information including information about the phase-shift sequences of the selected OFDM symbols may be generated.

The receiving end requires side information about the phase-shift sequences P^{(\tilde{v}}^{ᵢ}⁾ of all selected OFDM symbols in order to restore a reception signal.

Here, at step S360, the side information may be added to the selected OFDM symbols, and then a resulting signal may be output.

Here, at step S360, the side information may be added to the message block of the Physical Link Channel (PLC) frame in each selected OFDM symbol.

Further, at step S360, OFDM symbols including the side information may be primarily transmitted, and OFDM symbols corresponding to the side information may be output.

Here, at step S360, the side information may be included in the corresponding OFDM symbols without a PAPR cancellation technique being applied to the OFDM symbols including the side information.

Accordingly, the present invention may reduce signal distortion in an Orthogonal Frequency Division Multiplexing (OFDM) transmission signal in a full-duplex communication system.

Further, the present invention may reduce signal distortion by decreasing a PAPR occurring in a procedure for performing an IFFT on an OFDM signal.

Furthermore, the present invention may reduce the size of side information required for selective mapping (SLM) so as to effectively decrease a PAPR.

As described above, in the apparatus and method for reducing signal distortion according to the present invention, the configurations and schemes in the above-described embodiments are not limitedly applied, and some or all of the above embodiments can be selectively combined and configured such that various modifications are possible.

What is claimed is:

1. An apparatus for reducing signal distortion, comprising:
a signal input unit for receiving Orthogonal Frequency Division Multiplexing (OFDM) signals;
a symbol selection unit for selecting an OFDM symbol having a lowest Peak-to-Average-Power-Ratio (PAPR) by applying selective mapping (SLM) to the OFDM signals;
an information generation unit for generating side information that includes information about a phase-shift sequence of the selected OFDM symbol; and
a signal output unit for outputting a resulting signal by adding the side information to the selected OFDM symbol.

2. The apparatus of claim 1, wherein the signal output unit adds the side information to a message block of a Physical Link Channel (PLC) frame in the selected OFDM symbol.

3. The apparatus of claim 2, wherein the signal output unit primarily transmits an OFDM symbol including the side information and secondarily outputs an OFDM symbol corresponding to the side information.

4. The apparatus of claim 3, wherein the signal input unit outputs the OFDM signals such that the OFDM signals are divided into at least two OFDM signal groups.

5. The apparatus of claim 4, wherein the symbol selection unit generates OFDM symbol groups by applying selective mapping to each of the at least two OFDM signal groups.

6. The apparatus of claim 5, wherein the symbol selection unit calculates average PAPR values of OFDM symbols included in the at least two OFDM symbol groups and selects OFDM symbols having a lowest average PAPR.

7. The apparatus of claim 6, wherein the symbol selection unit calculates an average PAPR of OFDM symbols which are included in the at least two OFDM symbol groups and which are generated using an identical phase-shift sequence.

8. A method for reducing signal distortion, the method being performed using a signal distortion reduction apparatus, the method comprising:
receiving Orthogonal Frequency Division Multiplexing (OFDM) signals;
selecting an OFDM symbol having a lowest Peak-to-Average-Power-Ratio (PAPR) by applying selective mapping (SLM) to the OFDM signals;
generating side information that includes information about a phase-shift sequence of the selected OFDM symbol; and
outputting a resulting signal by adding the side information to the selected OFDM symbol.

9. The method of claim 8, wherein outputting the resulting signal is configured to add the side information to a message block of a Physical Link Channel (PLC) frame in the selected OFDM symbol.

10. The method of claim 9, wherein outputting the resulting signal is configured to primarily transmit an OFDM symbol including the side information and secondarily output an OFDM symbol corresponding to the side information.

11. The method of claim 10, wherein receiving the OFDM signals is configured to output the OFDM signals such that the OFDM signals are divided into at least two OFDM signal groups.

12. The method of claim 11, wherein selecting the OFDM symbol is configured to generate OFDM symbol groups by applying selective mapping to each of the at least two OFDM signal groups.

13. The method of claim 12, wherein selecting the OFDM signal is configured to calculate average PAPR values of OFDM symbols included in the at least two OFDM symbol groups and select OFDM symbols having a lowest average PAPR.

14. The method of claim 13, wherein selecting the OFDM signal is configured to calculate an average PAPR of OFDM symbols which are included in the at least two OFDM symbol groups and which are generated using an identical phase-shift sequence.
